(19) United States
(12) Patent Application Publication
(10) Pub. No.: US 2007/0280627 A1
(43) Pub. Date: Dec. 6, 2007

(54) Recording and playback of voice messages associated with note paper

(76) Inventor: James Marggraff, Lafayette, CA (US)

Correspondence Address: WAGNER, MURABITO & HAO LLP, Third Floor, Two North Market Street, San Jose, CA, 95113, US

(21) Appl. No.: 11/437,027

(22) Filed: May 19, 2006

(51) Int. Cl. H04N 5/91

(52) U.S. Cl. 386/46

(57) ABSTRACT

A method for recording and playback of voice messages associated with a surface. The method includes recognizing an actuation of a pen device on a detachable surface. The detachable surface is configured for removable attachment to a plurality of different surfaces, and comprises encoded information readable by the pen device. Upon actuation, an interactive audio function of the pen device is accessed. The interactive audio function provides functionality related to the encoded information of the detachable surface, and provides an audio output in accordance with the function.

### CROSS REFERENCES TO RELATED APPLICATIONS

This Application is related to the co-pending, commonly-owned U.S. patent application, Attorney Docket No. 020824-004610US, Ser. No. 10/803,806, filed Mar. 17, 2004, by James Marggraff et al., entitled “Scanning Apparatus,” and hereby incorporated by reference in its entirety.

This Application is related to the co-pending, commonly-owned U.S. patent application, Attorney Docket No. 020824-009500US, Ser. No. 10/861,243, filed Jun. 3, 2004, by James Marggraff et al., entitled “User Created Interactive Interface,” and hereby incorporated by reference in its entirety.

This Application is related to the co-pending, commonly-owned U.S. patent application, Attorney Docket No. LEAP-P0322P, Ser. No. 11/034,657, filed Jan. 12, 2005, by James Marggraff et al., entitled “Methods And Devices For Retrieving And Using Information Stored As A Pattern On A Surface,” and hereby incorporated by reference in its entirety.

### TECHNICAL FIELD

Embodiments of the invention relate to the control and use of interactive devices, computers, electronic devices, appliances, toys, and the like.

### BACKGROUND ART

Devices such as optical readers or optical pens conventionally emit light that reflects off a surface to a detector or imager. As the device is moved relative to the surface (or vice versa), successive images are rapidly captured. By analyzing the images, movement of the optical device relative to the surface can be tracked.

One type of optical pen is used with a sheet of paper on which very small dots are printed. The dots are printed on the page in a pattern with a nominal spacing of about 0.3 millimeters (0.01 inches). The pattern of dots within any region on the page is unique to that region. The optical pen essentially takes a snapshot of the surface, perhaps 100 times a second or more. By interpreting the dot positions captured in each snapshot, the optical pen can precisely determine its position relative to the page.

Applications that utilize information about the position of an optical pen relative to a surface have been or are being devised. An optical pen with Bluetooth or other wireless capability can be linked to other devices and used for sending electronic mail (e-mail) or faxes.

The increasing power of embedded computer systems and the complexity of the functions they are able to implement have created a need for a more intuitive and user-friendly manner of using such systems. A typical prior art optical pen will implement its intended functionality by the user operating one or more buttons/switches or controls of the optical pen to activate one or more software programs, routines, embedded devices, or the like. The pen may contain or be in communication with a computer system. Upon actuation of such controls, the pen device performs its intended function. Accessing the capabilities of increasingly powerful optical pens through the limited number and configuration of switches, buttons, etc., provided on the pen itself, or any remotely coupled computer system device, is not a satisfactory arrangement.

One prior art solution uses the optical pen to recognize a user-defined command, and uses that command to invoke some function of the pen (e.g., PCT publication WO/01/48590 A1). For example, a user's writing can be recognized (e.g., in real-time) and interpreted as a command for the optical pen. The drawback with this solution involves the fact that interaction and control of the functions of the pen requires real-time recognition of the user's handwriting (e.g., as the user writes the command down on a sheet of paper). This solution is not always satisfactory due to the fact that interaction with more complex functionality of an optical pen requires the user to repeatedly write-down one or more commands to access different choices, options, or functions provided by the pen. While the solution might be satisfactory for exceedingly simple, single step type applications (e.g., “turn off”, “store”, etc.), the solution is overly cumbersome and limiting in those cases where more complex, satisfying, rich functionality is desired.

### DISCLOSURE OF THE INVENTION

In one embodiment, the present invention is implemented as a method for recording and playback of voice messages associated with a surface. The surface is detachable and can be a paper note (e.g., Post-it® type note) having adhesive, or the like, on some portion so that the surface can be removably attached to a plurality of other different surfaces (e.g., desktops, appliance surfaces, bulletin boards, windows, etc.). In one embodiment, the detachable surface is magnetic for removable attachment to, for example, appliance surfaces and other types of magnetic surfaces. The method includes recognizing an actuation of a pen device on the detachable surface. The detachable surface comprises encoded information readable by the pen device. Upon actuation, an interactive audio function of the pen device is accessed. The interactive audio function provides functionality related to the encoded information of the detachable surface, and provides an audio output in accordance with the function.

In one embodiment, the interactive audio function is a note taking application and the detachable surface includes a number of pen recognizable graphic elements for managing the note taking application. Such graphic elements can be, for example, certain indicia indicating play, fast-forward, stop, playback, rewind, or erase, and can be used to manage a prerecorded audio output of, for example, a prerecorded voice message from a user. In one embodiment, the prerecorded audio output and the association of the prerecorded audio output with the detachable surface are stored on a remote server. This enables a playback of the audio output on a plurality of different pen devices via communication with the remote server.

These and other objects and advantages of the present invention will be recognized by one skilled in the art after having read the following detailed description, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a device upon which embodiments of the present invention can be implemented.

FIG. 2 is a block diagram of another device upon which embodiments of the present invention can be implemented.

FIG. 3 shows an exemplary sheet of paper provided with a pattern of marks according to one embodiment of the present invention.

FIG. 4 shows an enlargement of a pattern of marks on an exemplary sheet of paper according to one embodiment of the present invention.

FIG. 5 shows a diagram of a flowchart of the steps of a process in accordance with one embodiment of the present invention.

FIG. 6 shows an object surface and a detachable surface attached to the object surface in accordance with one embodiment of the present invention.

FIG. 7 illustrates a mechanism by which a pen device accesses and plays back audio outputs associated with a detachable surface that were recorded and associated with the detachable surface by a different pen device in accordance with one embodiment of the present invention.

FIG. 8 shows a diagram depicting the use of multiple pen devices with a set of detachable surfaces in accordance with one embodiment of the present invention.

### DETAILED DESCRIPTION OF THE EMBODIMENTS

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature

Some portions of the detailed descriptions, which follow, are presented in terms of procedures, steps, logic blocks, processing, and other symbolic representations of operations on data bits within a computer memory. These descriptions and representations are the means used by those skilled in the data processing arts to convey most effectively the substance of their work to others skilled in the art. A procedure, computer executed step, logic block, process, etc., are here, and generally, conceived to be self-consistent sequences of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “computing,” ” associating,” “generating,” or the like, refer to the action and processes of a microcontroller, computer system, or similar electronic computing device, that manipulates and transforms data represented as physical (electronic) quantities within registers and memories into other data similarly represented as physical quantities.

### Embodiments of the Invention

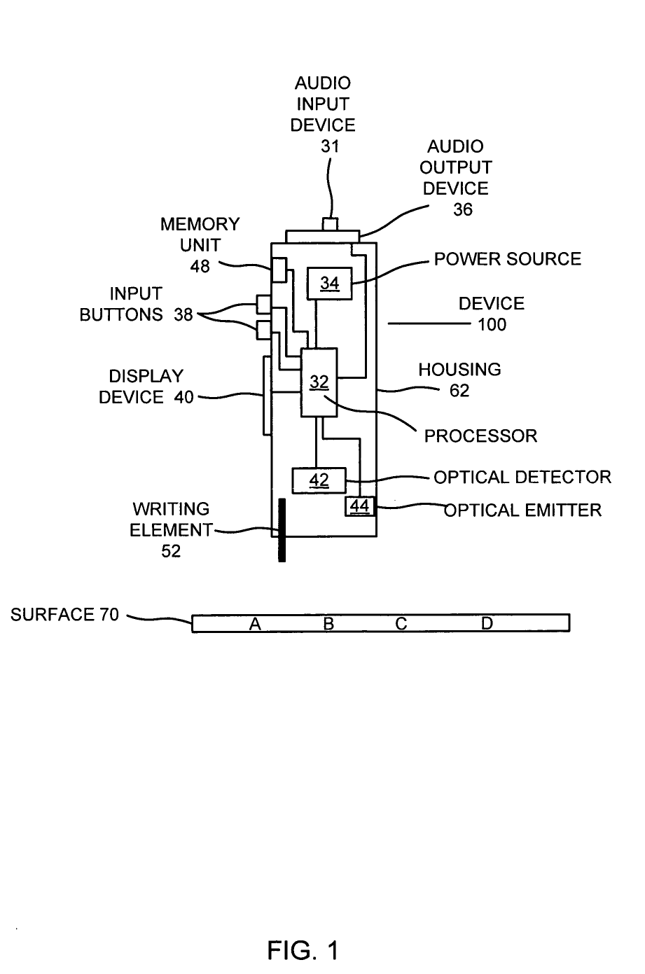

FIG. 1 is a block diagram of a pen device 100 upon which embodiments of the present invention can be implemented. In general, pen device 100 may be referred to as an optical device, more specifically as an optical reader, optical pen or digital pen. The device may contain a computer system and an operating system resident thereon. Application programs may also reside thereon.

In the embodiment of FIG. 1, pen device 100 includes a processor 32 inside a housing 62. In one embodiment, housing 62 has the form of a pen or other writing or marking utensil or instrument. Processor 32 is operable for processing information and instructions used to implement the functions of pen device 100, which are described below.

In the present embodiment, the pen device 100 may include an audio output device 36 and a display device 40 coupled to the processor 32. In other embodiments, the audio output device and/or the display device are physically separated from pen device 100, but in communication with pen device 100 through either a wired or wireless connection. For wireless communication, pen device 100 can include a transceiver or transmitter (not shown in FIG. 1). The audio output device 36 may include a speaker or an audio jack (e.g., for an earphone or headphone). The display device 40 may be a liquid crystal display (LCD) or some other suitable type of display.

In the embodiment of FIG. 1, pen device 100 may include input buttons 38 coupled to the processor 32 for activating and controlling the pen device 100. For example, the input buttons 38 allow a user to input information and commands to pen device 100 or to turn pen device 100 on or off. Pen device 100 also includes a power source 34 such as a battery.

Pen device 100 also includes a light source or optical emitter 44 and a light sensor or optical detector 42 coupled to the processor 32. The optical emitter 44 may be a light emitting diode (LED), for example, and the optical detector 42 may be a charge coupled device (CCD) or complementary metal-oxide semiconductor (CMOS) imager array, for example. The optical emitter 44 illuminates surface 70 or a portion thereof Light reflected from the surface 70 is received at and recorded by optical detector 42.

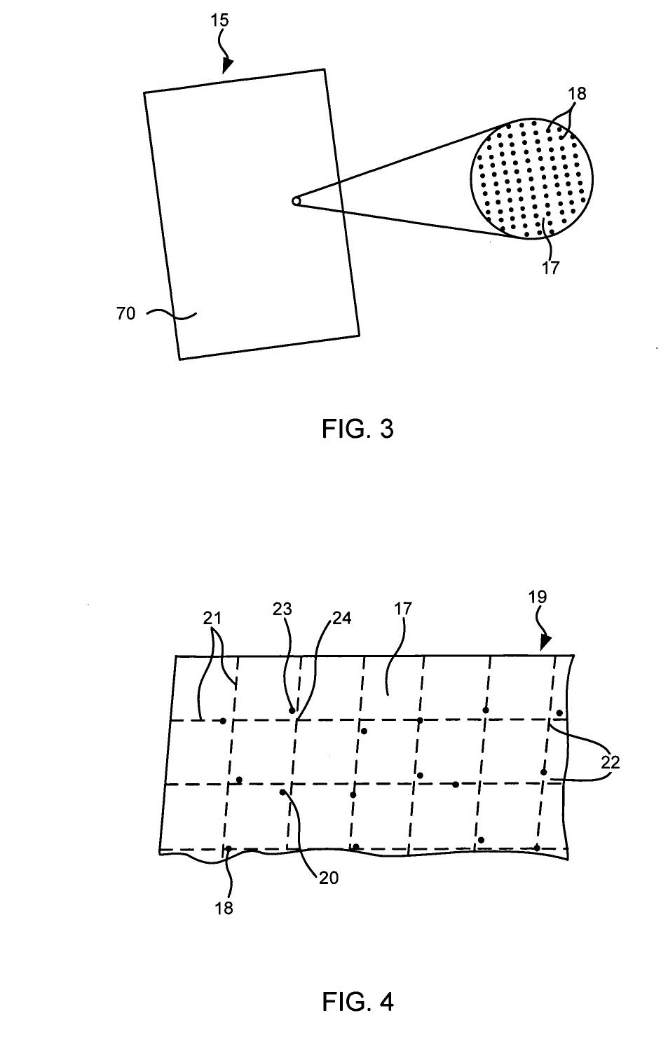

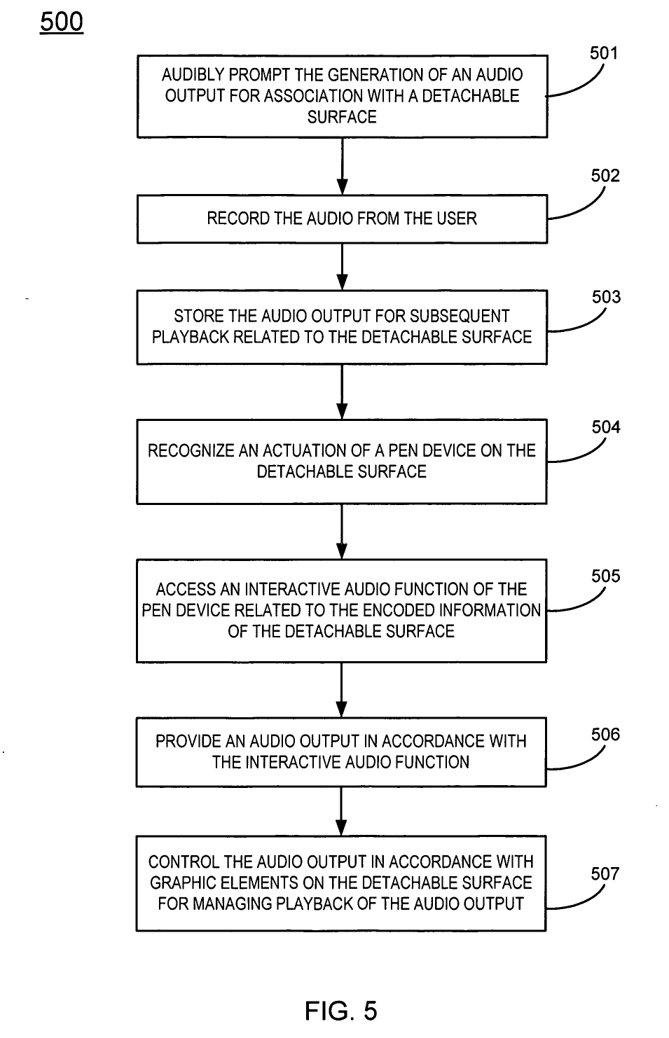

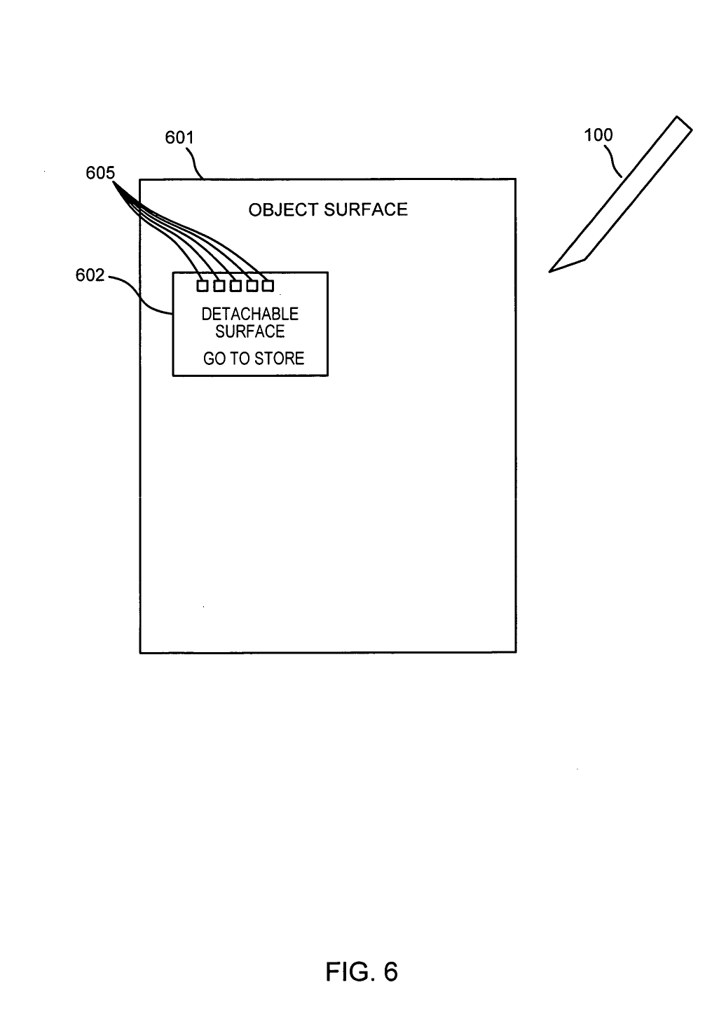

The surface 70 may be a sheet a paper, although the present invention is not so limited. In one embodiment, a pattern of markings is printed on surface 70. The end of pen device 100 that holds optical emitter 44 and optical detector 42 is placed against or near surface 70. As pen device 100 is moved relative to the surface 70, the pattern of markings are read and recorded by optical emitter 44 and optical detector 42. As discussed in more detail further below, in one embodiment, the markings on surface 70 are used to determine the position of pen device 100 relative to surface (see FIGS. 3 and 4). In another embodiment, the markings on surface 70 are used to encode information (see FIGS. 5 and 6). The captured images of surface 70 can be analyzed (processed) by pen device 100 to decode the markings and recover the encoded information.

Additional descriptions regarding surface markings for encoding information and the reading/recording of such markings by electronic devices can be found in the following patents and patent applications that are assigned to Anoto and that are all herein incorporated by reference in their entirety: U.S. Pat. No. 6,502,756, U.S. application Ser. No. 101179,966, filed on Jun. 26, 2002, WO 01/95559, WO 01/71473, WO 01/75723, WO 01/26032, WO 01/75780, WO 01/01670, WO 01/75773, WO 01/71475, WO 10 00/73983, and WO 01116691.

Pen device 100 of FIG. 1 also includes a memory unit 48 coupled to the processor 32. In one embodiment, memory unit 48 is a removable memory unit embodied as a memory cartridge or a memory card. In another embodiment, memory unit 48 includes random access (volatile) memory (RAM) and read-only (non-volatile) memory (e.g., ROM, Flash, EEPROM, etc.) for storing information and instructions for processor 32.

In the embodiment of FIG. 1, pen device 100 includes a writing element 52 situated at the same end of pen device 100 as the optical detector 42 and the optical emitter 44. Writing element 52 can be, for example, a pen, pencil, marker or the like, and may or may not be retractable. In certain applications, writing element 52 is not needed. In other applications, a user can use writing element 52 to make marks (e.g., graphical elements) on surface 70, including characters such as letters, words, numbers, mathematical symbols and the like. These marks can be scanned (imaged) and interpreted by pen device 100 according to their position on the surface 70. The position of the user-produced marks can be determined using a pattern of marks that are printed on surface 70; refer to the discussion of FIGS. 3 and 4, below. In one embodiment, the user-produced markings can be interpreted by pen device 100 using optical character recognition (OCR) techniques that recognize handwritten characters.

As mentioned above, surface 70 may be any surface suitable on which to write, such as, for example, a sheet of paper, although surfaces consisting of materials other than paper may be used. Also, surface 70 may or may not be flat. For example, surface 70 may be embodied as the surface of a globe. Furthermore, surface 70 may be smaller or larger than a conventional (e.g., 8.5×11 inch) page of paper.

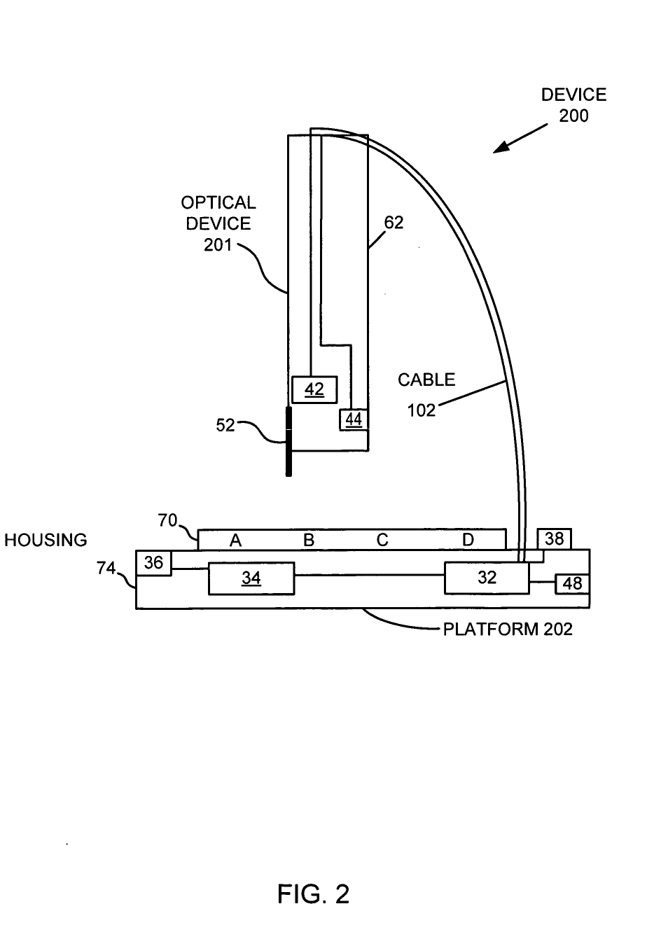

FIG. 2 is a block diagram of another device 200 upon which embodiments of the present invention can be implemented. Device 200 includes processor 32, power source 34, audio output device 36, input buttons 38, memory unit 48, optical detector 42, optical emitter 44 and writing element 52, previously described herein. However, in the embodiment of FIG. 2, optical detector 42, optical emitter 44 and writing element 52 are embodied as optical device 201 in housing 62, and processor 32, power source 34, audio output device 36, input buttons 38 and memory unit 48 are embodied as platform 202 in housing 74. In the present embodiment, optical device 201 is coupled to platform 202 by a cable 102; however, a wireless connection can be used instead. The elements illustrated by FIG. 2 can be distributed between optical device 201 and platform 200 in combinations other than those described above.

FIG. 3 shows a sheet of paper 15 provided with a pattern of marks according to one embodiment of the present invention. In the embodiment of FIG. 3, sheet of paper 15 is provided with a coding pattern in the form of optically readable position code 17 that consists of a pattern of marks 18. The marks 18 in FIG. 3 are greatly enlarged for the sake of clarity. In actuality, the marks 18 may not be easily discernible by the human visual system, and may appear as grayscale on sheet of paper 15. In one embodiment, the marks 18 are embodied as dots; however, the present invention is not so limited.

FIG. 4 shows an enlarged portion 19 of the position code 17 of FIG. 3. An optical device such as devices 100 and 200 (FIGS. 1 and 2) is positioned to record an image of a region of the position code 17. In one embodiment, the optical device fits the marks 18 to a reference system in the form of a raster with raster lines 21 that intersect at raster points 22. Each of the marks 18 is associated with a raster point 22. For example, mark 23 is associated with raster point 24. For the marks in an image/raster, the displacement of a mark from the raster point associated with the mark is determined. Using these displacements, the pattern in the image/raster is compared to patterns in the reference system. Each pattern in the reference system is associated with a particular location on the surface 70. Thus, by matching the pattern in the image/raster with a pattern in the reference system, the position of the pattern on the surface 70, and hence the position of the optical device relative to the surface 70, can be determined.

With reference back to FIG. 1, four positions or regions on surface 70 are indicated by the letters A, B, C and D (these characters are not printed on surface 70, but are used herein to indicate positions on surface 70). There may be many such regions on the surface 70. Associated with each region on surface 70 is a unique pattern of marks. The regions on surface 70 may overlap because even if some marks are shared between overlapping regions, the pattern of marks in a region is still unique to that region.

In the example of FIG. 1, using pen device 100 (specifically, using writing element 52), a user may create a character consisting, for example, of a circled letter “M” at position A on surface 70 (generally, the user may create the character at any position on surface 70). The user may create such a character in response to a prompt (e.g., an audible prompt) from pen device 100. When the user creates the character, pen device 100 records the pattern of markings that are uniquely present at the position where the character is created. The pen device 100 associates that pattern of markings with the character just created. When pen device 100 is subsequently positioned over the circled “M,” pen device 100 recognizes the pattern of marks associated therewith and recognizes the position as being associated with a circled “M.” In effect, pen device 100 recognizes the character using the pattern of markings at the position where the character is located, rather than by recognizing the character itself.

In one embodiment, the characters described above comprise “graphic elements” that are associated with one or more commands of the pen device 100. It should be noted that such graphic elements that are associated with, and are used to access the pen device 100 implemented functions comprising commands, are referred to as “graphic element icons” hereafter in order to distinguish from other written characters, marks, etc. that are not associated with accessing functions or applications of the pen device 100. In the example just described, a user can create (write) a graphic element icon that identifies a particular command, and can invoke that command repeatedly by simply positioning pen device 100 over the graphic element icon (e.g., the written character). In one embodiment, the writing instrument is positioned over the graphical character. In other words, the user does not have to write the character for a command each time the command is to be invoked by the pen device 100; instead, the user can write the graphic element icon for a command one time and invoke the command repeatedly using the same written graphic element icon.

In one embodiment, the graphic element icons can include a letter or number with a line circumscribing the letter or number. The line circumscribing the letter or number may be a circle, oval, square, polygon, etc. Such graphic elements appear to be like “buttons” that can be selected by the user, instead of ordinary letters and numbers. By creating a graphic element icon of this kind, the user can visually distinguish graphic element icons such as functional icons from ordinary letters and numbers, which may be treated as data by the pen device 100. Also, by creating graphic element icons of this kind, the pen device may also be able to better distinguish functional or menu item type graphic elements from non-functional or non-menu item type graphic elements. For instance, a user may create a graphic element icon that is the letter “M” which is enclosed by a circle to create an interactive “menu” graphic element icon.

The pen device 100 may be programmed to recognize an overlapping circle or square with the letter “M” in it as a functional graphic element as distinguished from the letter “M” in a word. The graphic element icon may also include a small “check mark” symbol adjacent thereto. Computer code for recognizing such functional graphic elements and distinguishing them from other non-functional graphic elements can reside in the memory unit in the pen device. The processor can recognize the graphic element icons and can identify the locations of those graphic element icons so that the pen device 100 can perform various functions, operations, and the like associated therewith. In these embodiments, the memory unit may comprise computer code for correlating any graphic elements produced by the user with their locations on the surface.

It should be noted that the generic term “graphic element” may include any suitable marking created by the user, and is distinguishable from a graphic element icon which refers to a functional graphic element that is used to access one or more functions of the device.

As mentioned above, it should be noted that graphic element icons can be created by the pen device 100 (e.g., drawn by the user) or can be pre-existing (e.g., a printed element on a sheet of paper). Example graphic elements include, but are not limited to symbols, indicia such as letters and/or numbers, characters, words, shapes, lines, etc. They can be regular or irregular in shape. User written/created graphic elements are typically created using the pen device 100.

In one embodiment of the invention, the pattern of marks 17 of FIG. 3 is very large and covers many thousands square miles before repeating if printed in entirety. In one embodiment of the invention, a portion of the pattern of marks is divided into different regions that are associated with different sizes of writing surface. For example, a portion of the pattern of marks can be associated with a 3″×5″ writing surface and a different portion of the pattern of marks can be associated with an 8.5″×11″ writing surface. Furthermore, the different portions of the pattern of marks can be selected in sequence, such that a plurality of pages of a notebook comprise associated patterns of marks in sequence. This allows recognition of a particular page number based on the particular pattern of dots.

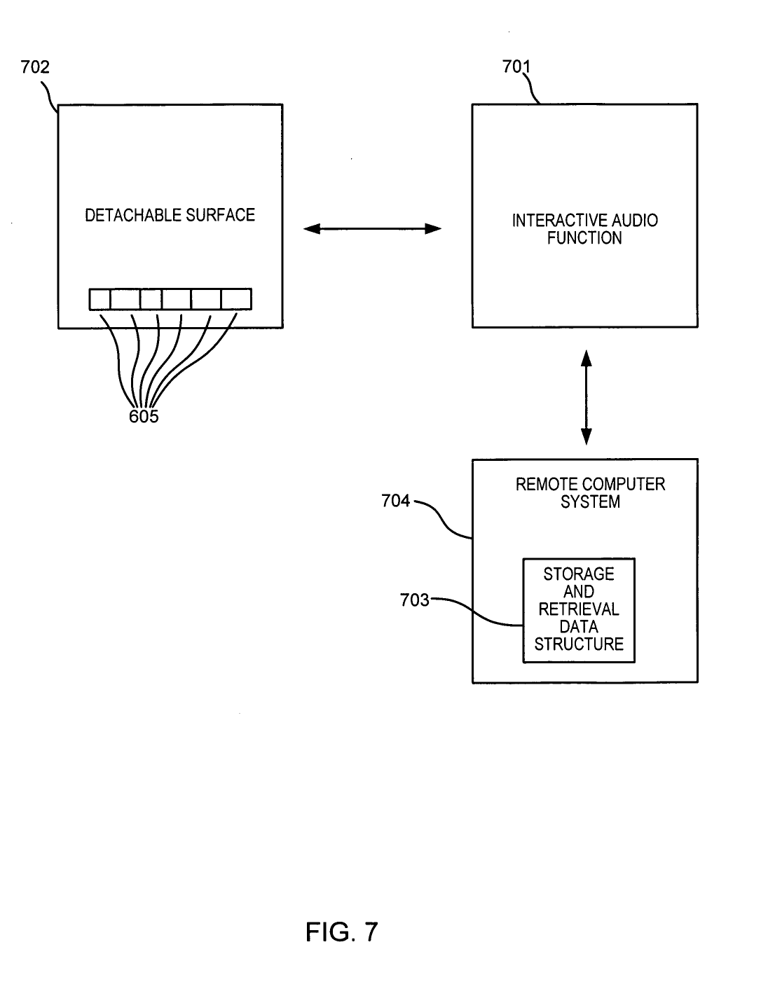

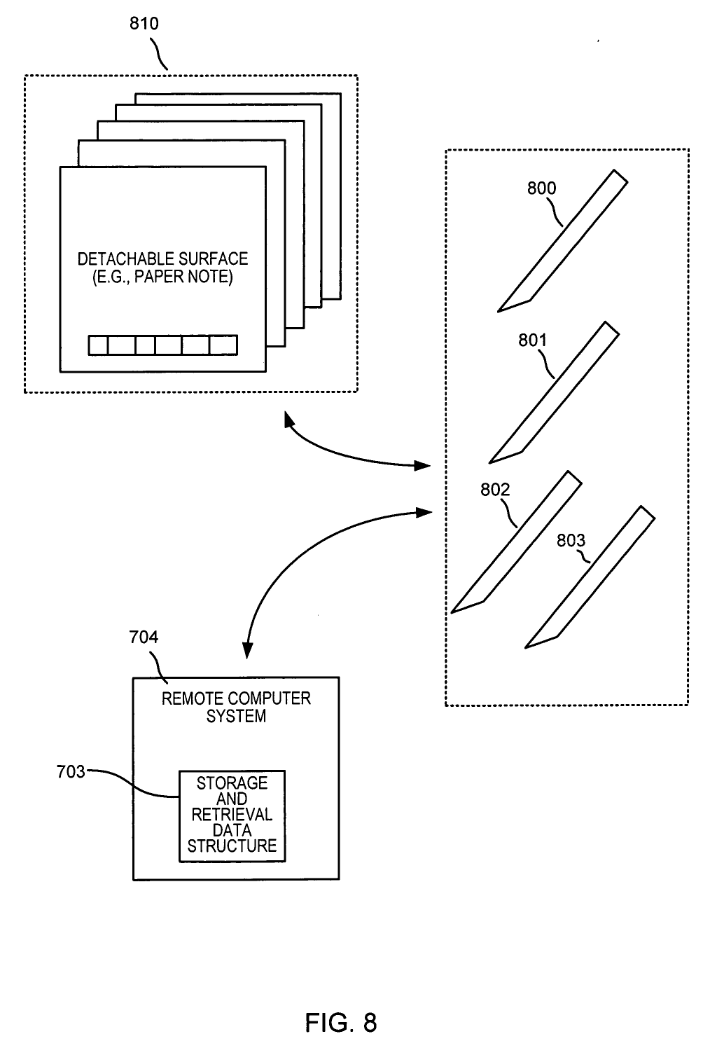

FIG. 5 shows a diagram of a flowchart of the steps of a process 500 in accordance with one embodiment of the present invention. As depicted in FIG. 5, process 500 shows the operating steps involved in an exemplary process for the recording and playback of voice messages associated with detachable surfaces such as paper notes, magnetic notes, or the like. It should be noted that the steps of process 500 are described with reference to the illustrations shown in FIG. 6, FIG. 7, and FIG. 8 below.

Process 500 shows an exemplary process for the recording and playback of audio messages associated with a surface. The surface is detachable and can be a paper note (e.g., Post-it® type note) having adhesive, or the like, on some portion of itself such that the detachable surface can be removably attached to a plurality of other different surfaces (e.g., desktops, appliance surfaces, bulletin boards, windows, etc.). In one embodiment, depending upon the requirements of a particular application, the detachable surface is magnetic for removable attachment to, for example, appliance surfaces and other types of magnetic surfaces. Magnetic attachment means can at times be more convenient and more durable than adhesive attachment means such as glue, tape, or the like. Other attachment means can be used, such as, for example, Velcro®, etc.

Process 500 begins in step 501, where a pen device, such as the pen device 100 of FIG. 1, audibly prompts a user for the generation of an audio output for association with a detachable surface (e.g., paper note, etc.). The audible prompts can be part of a routine for generating audio outputs for association with the detachable surface. The routine can be part of an interactive audio application that uses the pen device 100 to prompt the user through the generation of audio information (e.g., the spoken voice of the user) for storage and subsequent playback.

For example, in one embodiment, the pen device 100 can audibly prompt the initiation of a recording to generate the audio output. For example, the pen device can recognize an actuation on the detachable surface (e.g., a down touch on the detachable surface) as the invocation of a note taking interactive audio function, and in response thereto, audibly prompt the initiation of the recording that will be used as the audio output. For example, upon actuation, the pen device can audibly enunciate “you have invoked the note taking application” and then audibly enunciate “at the tone please began your recording” and then play a tone (e.g., beep, etc.) and then begin recording audio from the user (e.g., “George please pick up a can of dog food from the store . . . ”).

In step 502, after prompting the user for generation of the audio output, the pen device 100 records the audio from the user via a microphone 31, or other type of audio input device, (e.g., shown in FIG. 1).

In step 503, after the recording is complete, the pen device 100 can store the audio output for subsequent playback related to the particular detachable surface. For example, FIG. 6 shows an object surface 601 (e.g., tabletop, refrigerator surface, window, desktop, etc.) and a detachable surface 602 attached thereto. In a typical use, the pen device 100 prompts the user for the creation of the audio output as described in step 501 and stores the recorded audio (e.g., “George please pick up a can of dog food from the store . . . ). This recorded audio output is associated with the particular detachable surface 602. This attribute enables the user to write a note on the detachable surface 602 in addition to recording the audio output. For example the user could write “go to store” on the detachable surface 602. Subsequently, when a second user sees the hand written note on the detachable surface 602 (e.g., “go to store”) the user would intuitively know to actuate the pen device 100 on the detachable surface 602 (e.g., touch the detachable surface 602 with the tip of the pen 100), whereupon the user would then hear the recorded message as played back by the pen device 100 (e.g., “George please pick up a can of dog food from the store . . . ).

In one embodiment, the interactive audio application can record multiple messages for multiple audio outputs to be associated with the detachable surface 602. The application can, for example, prompt the user through the creation of several audio output messages. These messages can subsequently be accessed and selected (e.g., selected from a list of audibly announced choices) for playback. Similarly, the application can prompt the user to associate one or more prerecorded messages for use with the detachable surface 602. These prerecorded messages can be for example animal noises, instructions, musical tones, songs, or the like that the user wants associated with the detachable surface 602. In this manner, audio outputs which are not user voice recordings can be associated with the detachable surface 602.

In step 504, the pen device 100 recognizes an actuation on the detachable surface 602. As described above, the detachable surface 602 includes encoded information that is readable by the pen device 100. Markings comprising the encoded information are read by the optical detector 42 and are analyzed and decoded by the pen device 100 to recover the encoded information.

In step 505, the encoded information is used to invoke the interactive audio application/function that works with the detachable surface 602. The encoded information can uniquely identify the nature of the detachable surface 602. For example, the encoded information of the detachable surface 602 can identify the detachable surface 602 as being configured to work with the interactive audio application. In one embodiment, the interactive audio application is a note taking application and the encoded information identifies the surface 602 as, for example, “audio note paper” or audio Post-it notes® and thereby invoke the note taking application (e.g., causing the pen to audibly enunciate “note taking application”). The note taking application can then access the stored audio output (e.g., the audio output recorded in step 502) that is associated with the particular detachable surface 602.

In step 506, the pen device 100 provides the audio output (e.g., recorded in step 502) in accordance with the interactive audio application. For example, when a subsequent user comes along and touches the pen 100 to the detachable surface 602 (e.g., after seeing the handwritten note “go to store”), the interactive audio application of the pen device 100 will access the stored audio output and play back the audio output through, for example, its onboard audio output device 30.

In step 507, the audio output is controlled in accordance with graphic elements 605 on the detachable surface 602 for managing playback of the audio output. As described above, the interactive audio application/function can operate as a note taking application, and the detachable surface 602 can include pen recognizable graphic elements 605 for managing interactive audio functionality. The graphic elements can be recognizable to both the user and to the interactive audio application. For example, the graphic elements can be symbols or other indicia which each indicate to a user audio control functions such as play, fast-forward, stop, playback, rewind, or erase. The user would use these graphic elements by tapping upon one or more of them with the pen device 100 to control the playback, erasure, fast-forward, etc. of the audio output. The encoded information comprising the indicia indicate to the pen device 100 what functions to implement upon actuation. In one embodiment, the graphic elements are preprinted graphic elements on the detachable surface 602.

In one embodiment, the controls (e.g., graphic elements 605) are preprinted graphic elements on the back outside portion of the note (e.g., the opposite side of the surface 602) and can be used to run through one or more of the recorded messages (e.g., or even all of them) and to delete one or more of them. The ability to delete the messages associated with the surface 602 allows the surface 602 to be reused. For example, a thrifty user may choose avoid writing on the surface 602, and only record audio messages, then eventually erase the recorded audio messages to facilitate subsequent reuse.

In another embodiment, the interactive audio application can offer additional functionality through the use of other graphic elements (e.g., graphic elements 605) that could be, for example, pre-printed chronological settings to let a user specify an alarm or alert time for their message to be played, or enter other scheduler-type settings.

In this manner, embodiments of the present invention enable a user to affix, for example, a Post-it type note to a textbook page, a notebook page, a workbench, a desktop, or other similar types of Post-it note destinations, and enable the user to record a voice message, wherever and whenever they choose, for instant access with a touch. Embodiments of the present invention enable simple and intuitive control of rich satisfying interactive audio application functionality. For example, process 500 enables a user to tap the “Record/Stop” button graphic element (e.g., one of the graphic elements 605), say a message, and touch the “Record/Stop” button graphic element (e.g., another one of the graphic elements 605) again to stop recording. Touching a “Play” graphic element announces the recording. Touching a “Date” graphic element announces the Date and time the message was recorded. The functionality of the interactive audio application is provided in a simple and intuitive manner.

The following additional exemplary messages are described in order to further illustrate the utility, usefulness, and power of the interactive audio application of process 500. The paper note (e.g., the detachable surface 602), could include a handwritten message to “Call MJ” and can include an audio output reciting “Call Mary Jane at 925-259-1550”. The paper note 602 can be attached to the cover of a textbook (e.g., object surface 601) and can cause an audio output reciting “Study pages 36-40, 45-47 and 50-55 then do problems 6, 8, 12, and 14 on page 60”. Similarly, the paper note 602 can be attached to the dashboard 601 of a car and can cause an audio output reciting “Take the first left; go three blocks until you see Kentucky Fried Chicken®; turn right at the light onto Happy Valley Road; continue 0.7 miles and look for the green house on your right.” Alternatively, the directions might be spread across several paper notes.

Additional exemplary messages can include audio outputs such as “Be sure to review notes on Medieval Serfs and Fiefdoms. Mrs. Jones says this will be the central part of the test. And remember to review Feudal Contracts for extra credit.” Another audio output message could be “check out these cool websites www.bloglogs.com, www.snaptrack.com, and www.mspapes.com” or “OK Sue . . . I've taken your pen device when you weren't looking and am leaving this message for you . . . Austin thinks you're really cute!!! . . . and he'll be looking for you at the dance tonight . . . (giggles) . . . ”.

To maintain ready access to the interactive audio application, adults, teenagers and families, will want to keep the pen device 100 and paper notes (detachable surfaces such as detachable surface 602) handy. Kids may stick unused paper notes 602 in their notebooks, or around different places, just to have quick access to them.

Referring now to FIG. 7, a diagram depicting the detachable surface 602, an interactive audio function 701, and a remote computer system 704 in accordance with one embodiment of the present invention is shown. FIG. 7 illustrates the interaction between the interactive audio function 701 and the detachable surface 602, as described in the discussion of FIG. 5 above. FIG. 7 also illustrates a communications process between the interactive audio function 701 and a storage and retrieval data structure 703 hosted on a remote computer system 704.

The FIG. 7 embodiment illustrates one mechanism by which a pen device (e.g., pen device 100) accesses and plays back audio outputs associated with the detachable surface 702 that were recorded and associated with the detachable surface 702 by a different pen device (not shown). As depicted in FIG. 7, the interactive audio function 701 associates in audio output message with the detachable surface 702 and stores the audio output message and the association within a storage and retrieval data structure 703 of the remote computer system 704. The storage and retrieval data structure 703 can be a database or other similar type of computer readable structure.

The interactive audio function 702 can communicate with the remote computer system 704 through a number of different techniques. Such techniques include, for example, wireless communication with the remote computer system 704 (e.g., Bluetooth, WiFi, wireless modem, any of the 802.11 wireless protocols, etc.), or periodic communication with the remote computer system 704, whereby the pen device executing the interactive audio function 701 is periodically physically connected (e.g., is placed within a docking station or docking port directly coupled to the computer system 704). Similarly, the interactive audio function 701 can communicate with the remote computer system 704 via one or more intervening communications networks (e.g., Internet, intranet, etc.) by connecting via, for example, a desktop/laptop computer system.

The storage of the audio output message and the association with the detachable surface 702 within the storage and retrieval data structure 703 enables different interactive audio functions executing on different pen devices to query the storage and retrieval data structure 703 and retrieve and playback audio output messages associated with the detachable surface 702. This would allow, for example, a family to each access a paper note (e.g., detachable surface 702) on a refrigerator with their respective pen devices and access and play audio output messages recorded by any one of them. The pen devices could respectively belong to and remain with each of the family members as opposed to forcing the family to use a single pen device stored in a central location for use by all (e.g., a single pen device 100 stock on the refrigerator). This process is illustrated in FIG. 8 below.

FIG. 8 shows a diagram depicting the use of multiple pen devices 800-803 with a set of detachable surfaces 810 in accordance with one embodiment of the present invention. FIG. 8 illustrates a case where multiple pen devices 800-803 can be used to access one or more of the detachable surfaces of the set 810 and store and associate audio outputs with one or more of the detachable surfaces of the set 810 via the storage and retrieval data structure 703.

As described above, the storage of the audio output messages and their association with a given detachable surface within the storage and retrieval data structure 703 enables different interactive audio functions executing on different pen devices (e.g., pen devices 800-803) to query the storage and retrieval data structure 703 and retrieve and playback audio output messages associated with the detachable surface 702. The FIG. 8 embodiment further illustrates an application whereby the audio output accessing and playback functions can be used with a set of detachable surfaces 810.

In one exemplary embodiment, the set of detachable surfaces 810 can comprise, for example, a notepad of 50 or so paper notes. Each of the paper notes of the notepad (e.g., set 810) can have an identity or a characteristic which associates each of the notes with the notepad. This enables each of the notes to be identified with the notepad. This identity characteristic enables one or more attributes designated for the notepad to be likewise designated for each of the notes comprising the notepad. For example, each of the notes comprising the notepad can be configured to automatically enunciate the owner of the notepad or the notepad's application, such as, “David's notes” or “science homework notes”. Similarly, the identity characteristic enables operation on a specific pad to affect all the notes within the notepad. Thus, in one embodiment, the encoded information comprising a given detachable surface is unique per each detachable surface of the set 810, and each detachable surface is associated with the set 810 to enable one operation on one detachable surface of the set 810 to affect the other detachable surfaces of the set 810.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for recording and playback of voice messages associated with a surface, comprising:
recognizing an actuation of a pen device on a detachable surface, wherein the detachable surface is configured for removable attachment to a plurality of different surfaces, and wherein the detachable surface comprises encoded information readable by the pen device;
accessing an interactive audio function of the pen device related to the encoded information of the detachable surface; and
providing an audio output in accordance with the function.

2. The method of claim 1 wherein the detachable surface is a paper note.

3. The method of claim 1 wherein the detachable surface is a magnetic note.

4. The method of claim 1 wherein the detachable surface is reusable.

5. The method of claim 1 wherein the interactive audio function is a note taking application, and wherein the detachable surface includes pen recognizable graphic elements for managing the interactive audio function.

6. The method of claim 5, wherein at least one of the graphic elements comprises an indicia indicating play, fast-forward, stop, playback, rewind, or erase.

7. The method of claim 6, wherein the audio output is provided by the note taking application and comprises prerecorded audio output associated with the detachable surface.

8. The method of claim 7, wherein the prerecorded audio output is recorded by the pen device during an association process of the prerecorded audio output with the detachable surface.

9. The method of claim 8, wherein the prerecorded output audio comprises recorded voice audio of a user.

10. The method of claim 8, wherein the prerecorded audio output comprises one of a plurality of user selectable audio messages.

11. The method of claim 8, wherein the association of the prerecorded audio output with the detachable surface is stored on a remote server to enable a playback of the audio output on a plurality of different pen devices via communication with the remote server.

12. A note taking method for recording and playback of voice messages by using a pen device, comprising:
recognizing an actuation of a pen device on one detachable surface out of a set of detachable surfaces, wherein each of the detachable surfaces are reusable and configured for removable attachment to a plurality of different surfaces;
accessing note taking application of the pen device related to the one detachable surface by reading encoded information comprising the detachable surface;
providing an audio output in accordance with the note taking application, wherein the audio output has been previously associated with the one detachable surface by the pen device.

13. The method of claim 12 wherein the set of detachable surfaces comprise a set of paper notes.

14. The method of claim 12 wherein the set of detachable surfaces comprise a set of magnetic notes.

15. The method of claim 12 wherein the encoded information comprising the detachable surface is unique per each detachable surface of the set, and wherein each detachable surface is associated with the set to enable one operation on one detachable surface to affect the other detachable surfaces of the set.

16. The method of claim 12, further comprising:
audibly prompting an initiation of a recording to generate the audio output;
upon initiation, recording audio from a user;
audibly prompting an association of the audio output with the one detachable surface; and
storing the audio output for subsequent playback related to the one detachable surface.

17. The method of claim 16, wherein a plurality of unique audio outputs are recorded by the pen device and associated with the set of detachable surfaces respectively.

18. The method of claim 12 wherein the one detachable surface includes pen recognizable graphic elements for managing the note taking application.

19. The method of claim 18, wherein at least one of the graphic elements comprises an indicia indicating play, fast-forward, stop, playback, rewind, or erase.

20. The method of claim 18, wherein at least one of the graphic elements comprises a date indicia, and whereupon actuation causes the pen device to audibly output a date the audio from the user was recorded.

21. A pen device comprising:
an optical sensor for sensing images on a detachable surface;
a writing instrument;
a processor coupled to a bus;
a speaker;
a memory coupled to said bus and comprising instructions that when executed implement a method of interpreting user commands comprising:
recognizing an actuation of the pen device on the detachable surface, wherein the detachable surface is configured for removable attachment to a plurality of different surfaces, and wherein the detachable surface comprises encoded information readable by the pen device;
accessing an interactive audio function of the pen device related to the encoded information of the detachable surface; and
providing an audio output in accordance with the function.

22. The device of claim 21, wherein the detachable surface is a paper note.

23. The device of claim 21, wherein the detachable surface is a magnetic note.

24. The device of claim 21, wherein the encoded information comprising the detachable surface is unique per each of a plurality of detachable surfaces.

25. The device of claim 21, wherein the interactive audio function is a note taking application.

26. The device of claim 25, wherein the note taking application is configured to provide the audio output, and wherein the audio output is related to the detachable surface.

27. The device of claim 26, wherein the audio output is a prerecorded audio output previously associated with the detachable surface by the note taking application.

28. The device of claim 27, wherein the prerecorded audio output is recorded by the pen device during an association process of the prerecorded audio output with the detachable surface.

29. The device of claim 27, wherein the note taking application is configured to implement the association process by:
audibly prompting an initiation of a recording to generate the audio output;
upon initiation, recording audio from a user;
audibly prompting an association of the audio output with the one detachable surface; and
storing the audio output for subsequent playback related to the one detachable surface.

30. The device of claim 27, wherein the prerecorded audio output comprises one of a plurality of user selectable audio messages.

31. The device of claim 21 wherein the detachable surface is reusable.

32. The device of claim 21 wherein the interactive audio function is a note taking application, and wherein the detachable surface includes pen recognizable graphic elements for managing the interactive audio function.

33. The device of claim 32, wherein at least one of the graphic elements comprises an indicia indicating play, fast-forward, stop, playback, rewind, or erase.

34. The device of claim 21 wherein the encoded information comprising the detachable surface is unique per each of a plurality of detachable surfaces, and wherein each detachable surface is associated with a set of detachable surfaces to enable one operation on one detachable surface of the set to affect other detachable surfaces of the set.
